(19) United States
(12) Patent Application Publication
(10) Pub. No.: US 2025/0096230 A1
(43) Pub. Date: Mar. 20, 2025

(54) BATTERY AND METHOD FOR MANUFACTURING THE SAME

(71) Applicant: TOYOTA JIDOSHA KABUSHIKI KAISHA, Toyota-shi, Aichi-ken (JP)

(72) Inventors: Ryo ASAKURA, Sunto-gun, Shizuoka-ken (JP); Shinya SHIOTANI, Nagoya-shi, Aichi-ken (JP); Sakina KANEKO, Fujisawa-shi, Kanagawa-ken (JP)

(73) Assignee: TOYOTA JIDOSHA KABUSHIKI KAISHA, Toyota-shi, Aichi-ken (JP)

(21) Appl. No.: 18/675,475

(22) Filed: May 28, 2024

(30) Foreign Application Priority Data
Sep. 20, 2023 (JP) 2023-152280

(51) Int. Cl. H01M 4/134; H01M 4/02; H01M 4/04; H01M 10/058

(52) U.S. Cl. CPC H01M 4/134; H01M 4/0421; H01M 10/058; H01M 2004/027

(57) ABSTRACT

In the present disclosure, a battery utilizing a deposition dissolution reaction of metallic lithium as a negative electrode reaction, wherein an anode current collector, a metal layer, an electrolyte layer, and a cathode active material layer are provided in this order in the thickness direction. The above-described metal layer contains a Li−Mg alloy phase and a Li−Ga alloy phase, thereby solving the above-described problem.

### CROSS-REFERENCE TO RELATED APPLICATION

This application claims priority to Japanese Patent Application No. 2023-152280 filed on Sep. 20, 2023, incorporated herein by reference in its entirety.

### BACKGROUND

### 1. Technical Field

The present disclosure relates to a battery and a method for manufacturing the same.

### 2. Description of Related Art

A battery generally includes an electrolyte layer between a cathode active material layer and an anode active material layer. Batteries using a precipitation-dissolution reaction of metallic lithium as an anode reaction are known in the field of batteries. For example, Japanese Unexamined Patent Application Publication No. 2020-184513 (JP 2020-184513 A) discloses an all-solid-state battery using a precipitation-dissolution reaction of metallic lithium as an anode reaction.

### SUMMARY

In a battery using a precipitation-dissolution reaction of metallic lithium as an anode reaction, a common anode active material layer (layer containing anode active material particles that store and release Li) is generally not provided at the time of manufacturing the battery, and an anode active material layer (Li-containing layer) is formed by initial charge. Therefore, there is an advantage in that the energy density can easily be improved. In the battery using a precipitation-dissolution reaction of metallic lithium as an anode reaction, there is room for further improvement in discharge capacity characteristics.

The present disclosure has been made in view of the above circumstances, and a main object thereof is to provide a battery having good discharge capacity characteristics.

(1) A battery using a precipitation-dissolution reaction of metallic lithium as an anode reaction, the battery including
an anode current collector, a metal layer, an electrolyte layer, and a cathode active material layer in this order in a thickness direction, in which
the metal layer contains a Li−Mg alloy phase and a Li−Ga alloy phase.

(2) The battery according to (1), in which a ratio of Ga to a total of Ga and Mg in the metal layer is equal to or higher than 5 at % and equal to or lower than 80 at %.

(3) The battery according to (1) or (2), in which a ratio of Ga to a total of Ga and Mg in the metal layer is equal to or higher than 72 at % and equal to or lower than 85 at %.

(4) A battery using a precipitation-dissolution reaction of metallic lithium as an anode reaction, the battery including
an anode current collector, a metal layer, an electrolyte layer, and a cathode active material layer in this order in a thickness direction, in which
the metal layer contains a Mg−Ga alloy.

(5) A method for manufacturing a battery using a precipitation-dissolution reaction of metallic lithium as an anode reaction, the method including:
a metal layer forming step for forming a metal layer containing a Mg−Ga alloy phase by vapor deposition; and
an assembling step for assembling the battery including an anode current collector, the metal layer, an electrolyte layer, and a cathode active material layer in this order in a thickness direction.

The battery according to the present disclosure has an effect of having good discharge capacity characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view illustrating a battery according to the present disclosure;

FIG. 1B is a schematic cross-sectional view illustrating the battery according to the present disclosure;

FIG. 2 is an explanatory diagram for explaining a state of a battery in the present disclosure during charging;

FIG. 3 is an explanatory diagram for explaining a state of a battery in the present disclosure at the time of discharge;

FIG. 4 shows the results of charge/discharge tests in the evaluation cells prepared in Examples 1 to 5 and Comparative Examples 1 and 2;

FIG. 5 shows the results of charge-discharge tests in the evaluation cells prepared in Examples 1 to 5 and Comparative Examples 1 and 2; and

FIG. 6 is a cross-sectional SEM image of the evaluating cell produced in the fifth embodiment.

### DETAILED DESCRIPTION OF EMBODIMENTS

Hereinafter, a battery and a manufacturing method thereof according to the present disclosure will be described in detail with reference to the drawings. Each drawing shown below is schematically shown, and the size and shape of each part are appropriately exaggerated for easy understanding.

### A. Battery

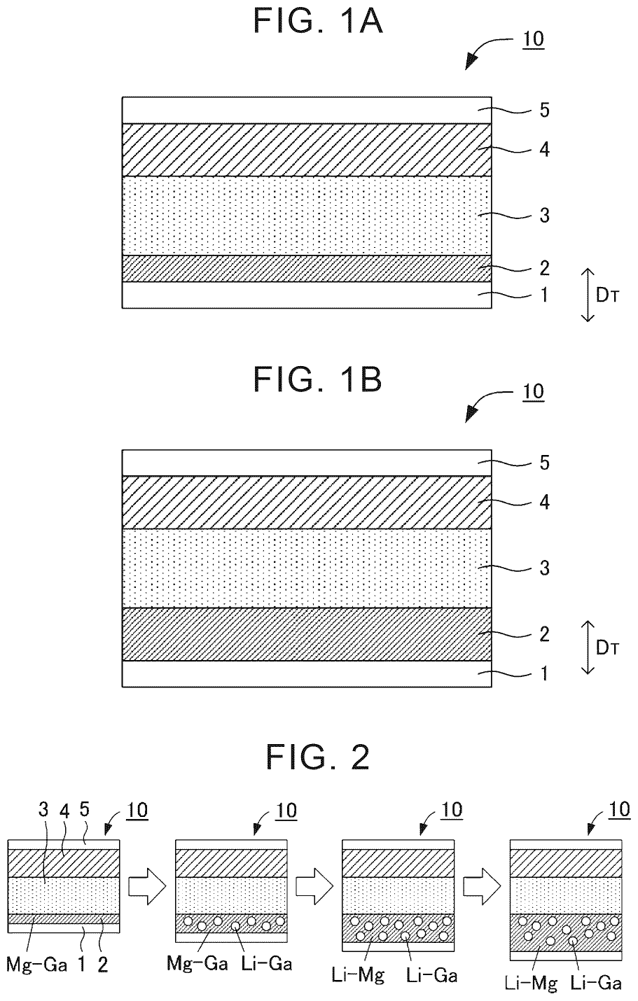

FIG. 1A and FIG. 1B are schematic cross-sectional views illustrating a battery according to the present disclosure. Specifically, FIG. 1A is a schematic cross-sectional view illustrating a battery prior to initial charging, and FIG. 1B is a schematic cross-sectional view illustrating a battery after initial charging.

As illustrated in FIG. 1A and FIG. 1B, the battery 10 includes the anode current collector 1, the metal layer 2, the electrolyte layer 3, and the cathode active material layer 4 in this order in the thickness direction DT. Normally, the positive electrode current collector 5 is disposed on the side opposite to the electrolyte layer 3 with respect to the cathode active material layer 4. In addition, as shown in FIG. 1A, in the battery 10 prior to the first charge, the metal layer 2 contains Mg−Ga alloy. The metal layer 2 is typically a vapor-deposited layer having a Mg−Ga alloying phase. On the other hand, when the battery 10 shown in FIG. 1A is charged, Mg−Ga alloy phase and Li react to form Li−Mg alloy phase and Li−Ga alloy phase from Mg−Ga alloy phase. Consequently, as shown in FIG. 1B, in the battery 10 after the initial charge, the metal layer 2 contains a Li−Mg alloy phase and a Li−Ga alloy phase.

According to the present disclosure, since metal layer includes Mg and Ga, batteries having good discharge-capacity properties. As described above, in a battery using a metal-lithium precipitation-dissolution reaction as a negative electrode reaction, a common anode active material layer (for example, a layer containing negative electrode active material particles that occlude and release Li) is not provided at the time of manufacturing the battery, and the anode active material layer (Li containing layer) is formed by initial charge. On the other hand, in a battery using a precipitation and dissolution reaction of metallic lithium as a negative electrode reaction, there is room for further improvement in discharge capacity characteristics.

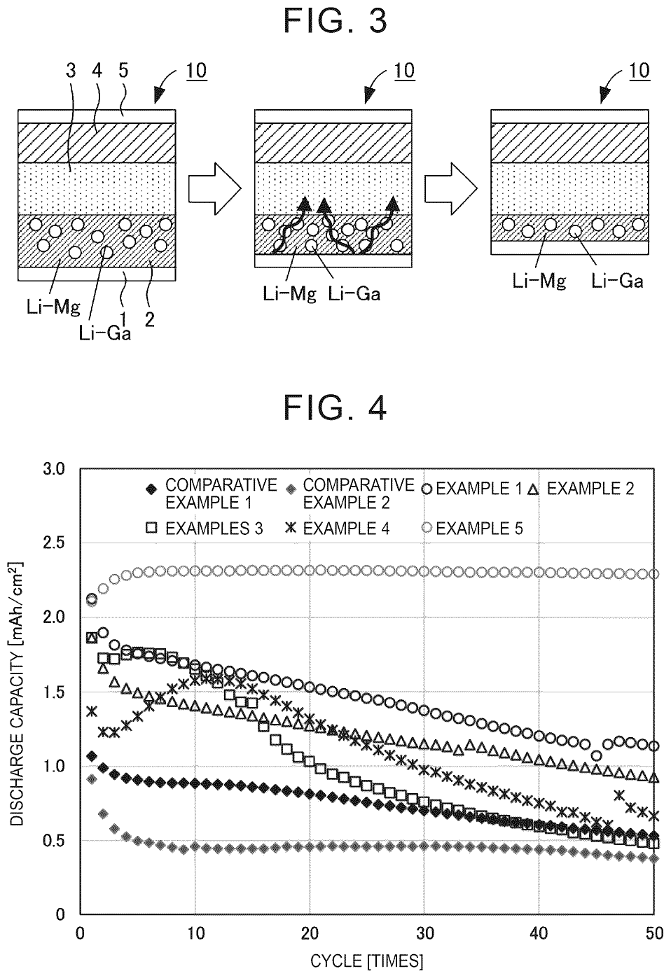

On the other hand, metal layers including Mg and Ga are used in the present disclosure. By using such a metal layer, good discharge capacity characteristics can be obtained. It is presumed that the reason why good discharge capacitance properties can be obtained is that the use of metal layers containing Mg and Ga can suppress an increase in the resistivity of the negative electrode in the end-of-discharge period. Hereinafter, effects obtained in the present disclosure will be described in detail with reference to FIGS. 2 and 3.

As illustrated in the leftmost part of FIG. 2, the battery 10 includes the anode current collector 1, the metal layer 2, the electrolyte layer 3, the cathode active material layer 4, and the positive electrode current collector 5 in this order in the thickness direction. The metal layer 2 has a Mg−Ga alloying phase. Next, as shown second from the left in FIG. 2, when the battery 10 is started to be charged, a Li−Ga alloy phase is first formed from a part of Mg−Ga alloy phase. Ga reacts prior to Mg with Li to form a Li−Ga alloyed phase because of the higher reactive potential of Li intercalation and deintercalation than Mg. Next, as shown in the third and fourth figures from the left of FIG. 2, when the battery 10 is charged, a Li−Mg alloy phase is formed in addition to Li−Ga alloy phase. Li−Ga alloy phase is formed before Li−Mg alloy phase, so that Li−Ga alloy phase is dispersed with respect to Li−Mg alloy phase.

Next, as shown in the left-hand diagram of FIG. 3, when the charged battery 10 is discharged, Li contained in the metal layer 2 is transferred to the cathode active material layer 4 via the electrolyte layer 3. At this time, since Mg has a lower reactive potential for Li intercalation and deintercalation than Ga, Li is first desorbed from Li−Mg alloy phase. As shown in the central view of FIG. 3, Li−Ga alloy phase has a higher Li ionic conductivity, so that a good ion conduction pass is formed. As shown in the right figure of FIG. 3, it is presumed that Li−Ga alloy phase is maintained even in the end-of-discharge period, and thus it is presumed that the resistance of the negative electrode can be suppressed from increasing. As a result, it is presumed that good discharge capacity characteristics can be obtained.

The disclosed battery can be broadly divided into two embodiments depending on State of Charge, SOC. Hereinafter, the battery according to the present disclosure will be described separately in the first embodiment and the second embodiment.

### 1. First Embodiment

As shown in the left figure of FIG. 3, the battery 10 according to the first embodiment includes the anode current collector 1, the metal layer 2, the electrolyte layer 3, and the cathode active material layer 4 in this order in the thickness direction. Furthermore, the metal layer 2 contains a Li−Mg alloy phase and a Li−Ga alloy phase.

### (1) Negative Electrode

The negative electrode in the first embodiment has an anode current collector. Examples of the anode current collector include SUS, copper, nickel, and carbon. Examples of the shape of the anode current collector include a foil shape. The thickness of the anode current collector is, for example, 1 μm or more and 500 μm or less.

The negative electrode has a metal layer. The metal layers contain a Li−Mg alloy phase and a Li−Ga alloy phase. Li−Mg alloy phase is a metallic phase of an alloy comprising Li and Mg, may be a metallic phase of a binary alloy comprising Li and Mg, and may be a metallic phase of an alloy comprising other elements in addition to Li and Mg. In the latter-case, it is preferred that Li and Mg are the main components in Li−Mg alloy phase. “Principal component” means that the content (at %) of the components contained in the metallic phase is largest. In Li−Mg alloying phase, the ratio of the sum of Li and Mg to all elements is, for example, 50 at % or more, may be 70 at % or more, and may be 90 at % or more.

Li−Ga alloy phase is a metallic phase of an alloy comprising Li and Ga, may be a metallic phase of a binary alloy comprising Li and Ga, and may be a metallic phase of an alloy comprising other elements in addition to Li and Ga. In the latter-case, it is preferred that Li and Ga are the main components in Li−Ga alloy phase. In Li−Ga alloying phase, the ratio of the sum of Li and Ga to all elements is, for example, 50 at % or more, may be 70 at % or more, and may be 90 at % or more.

The metal layers have both a Li−Ga alloy phase and a Li−Mg alloy phase. In particular, in the metal layers, Li−Ga alloy phase is preferably dispersed in Li−Mg alloy phase. That is, it is preferable that a sea-island structure in which Li−Mg alloy phase is sea and Li−Ga alloy phase is island is formed. This is because it is possible to suppress an increase in resistance in the negative electrode in the end-of-discharge period. Size of Li−Ga alloy phase is not particularly limited, for example, 0.1 μm or more, is 5 μm or less, the size of Li−Ga alloy phase can be determined from the distribution of Ga by SEM-EDX. The size of Li−Ga alloy phase is the mean of the measured sizes of 100 or more samples.

The ratio of Ga to the sum of Ga and Mg (Ga/(Ga+Mg)) in the metal layers is not particularly limited. Ga/(Ga+Mg) is, for example, 5 at % or more, may be 10 at %, may be 15 at % or more, may be 20 at % or more, may be 25 at % or more. On the other hand, Ga/(Ga+Mg) is, for example, less than or equal to 90 at %, and may be less than or equal to 85 at %.

The metal layer preferably does not contain a conductive material. The metal layer preferably does not contain a binder. In addition, a Li phase may be formed inside the metal layers. In addition, a deposited Li layer may be formed between the metal layer and the electrolyte layer. Further, a deposited Li layer may be formed between the metal layer and the anode current collector.

The metal layer is usually a dense layer. The porosity of the metal layer (the ratio of the area of the voids in the cross section of the metal layer) is, for example, 5% or less, may be 3% or less, and may be 1% or less. In addition, in the first embodiment, the thickness of the metal layer is not particularly limited, but is, for example, 5 μm or more and 30 μm or less.

As shown in the left figure of FIG. 3, the metal layer 2 may be in direct contact with the anode current collector 1. Similarly, the metal layer 2 may be in direct contact with the electrolyte layer 3. On the other hand, although not particularly shown, other layers may be disposed between the metal layer and the anode current collector. Similarly, other layers may be disposed between the metal layer and the electrolyte layer. As shown in FIG. 3, the discharged metal layer 2 may contain a Li−Mg alloy phase and a Li−Ga alloy phase. Depending on SOC, the discharged metal layers may contain a Mg phase containing no Li and a Li−Ga alloying phase. Similarly, the post-discharge metal layers may contain a Li free Mg phase and a Ga phase that does not contain Li.

### (2) Positive Electrode

The positive electrode in the first embodiment includes a positive electrode current collector and a cathode active material layer. The cathode active material layer contains at least a positive electrode active material. The cathode active material layer may contain at least one of an electrolyte, a conductive material, and a binder.

Examples of the positive electrode active material include an oxide active material. Examples of the oxide active material include rock salt-type layered active materials such as LiCoO₂, LiNi_{1/3}CO_{1/3}Mn_{1/3}O₂, spinel-type active materials such as LiMn₂O₄, Li₄Ti₅O₁₂, and olivine-type active materials such as LiFePO₄. Examples of the shape of the positive electrode active material include particulate. The mean particle diameter (D₅₀) of the positive electrode active material is, for example, 0.5 μm or more and 50 μm or less. The mean particle diameter (D₅₀) refers to the volume cumulative particle size measured by a laser diffractive scattering-particle sizing instrument.

Examples of the electrolyte include a solid electrolyte. Examples of the solid electrolyte include inorganic solid electrolytes such as a sulfide solid electrolyte, an oxide solid electrolyte, and a halide solid electrolyte. The sulfide solid electrolyte preferably contains sulfur(S) as a main component of the anionic element. The oxide solid electrolyte preferably contains oxygen (O) as a main component of the anionic element. The halide solid electrolyte preferably contains halogen (X) as a main component of the anion. Among these, a sulfide solid electrolyte is preferable.

The sulfide solid electrolyte preferably contains an Li element, an M element (M is at least one of P, Sn, Al, Zn, In, Ge, Si, Sb, Ga, and Bi), and an S element. The sulfide solid electrolyte may contain a halogen element such as F, Cl, Br, or I. In the sulfide solid electrolyte, a part of the S element may be substituted with an O element.

The sulfide solid electrolyte may be a glass-based (amorphous-based) sulfide solid electrolyte, a glass-ceramic-based sulfide solid electrolyte, or a crystalline sulfide solid electrolyte. Examples of the crystalline phase contained in the sulfide solid electrolyte include a LGPS crystalline phase, a Thio-LISICON crystalline phase, and an argyrodite crystalline phase.

Examples of the sulfide solid electrolyte include Li₂S—P₂S₅, Li₂S—P₂S₅—LiI, Li₂S—P₂S₅—GeS₂, Li₂S-P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m and n are positive numbers. Z is any of Ge, Zn, Ga), Li₂S—GeS₂, Li₂S—SiS₂—Li₃PO₄, Li₂S—SiS₂-LiₓMO_{y} (where x and y are positive numbers. M is any of P, Si, Ge, B, Al, Ga, In).

Other examples of solid electrolytes include organic solid electrolytes such as polymer electrolytes and gel electrolytes. As the electrolyte, a liquid electrolyte (electrolytic solution) can also be used.

Examples of the conductive material include a carbon material. Examples of the carbon material include particulate carbon materials such as acetylene black (AB) and Ketjen black (KB); and fibrous carbon materials such as carbon fiber, carbon nanotube (CNT), and carbon nanofiber (CNF). Examples of the binder include rubber-based binders such as butylene rubber (BR) and styrene butadiene rubber (SBR), and fluoride-based binders such as polyvinylidene fluoride (PVDF). The thickness of the cathode active material layer is, for example, 1 μm or more and 500 μm or less.

Examples of the positive electrode current collector include SUS, aluminum, nickel, and carbon. Examples of the shape of the positive electrode current collector include a foil shape. The thickness of the positive electrode current collector is, for example, 1 μm or more and 500 μm or less.

### (3) Electrolyte Layer

The electrolyte layer in the first embodiment contains at least an electrolyte. The electrolyte is the same as described in “(2) Positive electrode” above. Among them, the electrolyte layer preferably contains a solid electrolyte as an electrolyte. That is, the electrolyte layer is preferably a solid electrolyte layer containing a solid electrolyte. A battery having a solid electrolyte layer is sometimes referred to as an all-solid-state battery. The solid electrolyte layer may contain a binder in addition to the solid electrolyte. The binder is the same as described in “(2) Positive electrode” above. The thickness of the electrolyte layer is, for example, 1 μm or more and 500 μm or less.

### (4) Battery

The battery according to the first embodiment includes an anode current collector, a metal layer, an electrolyte layer, and a cathode active material layer in this order in the thickness direction. In addition, batteries typically have an exterior body that houses these components. Examples of the exterior body include a laminate-type exterior body and a case-type exterior body.

Applications of batteries include, but are not limited to, power supplies for vehicles such as hybrid electric vehicle (HEV), plug-in hybrid electric vehicle (PHEV), battery electric vehicle (BEV), gasoline-powered vehicles, diesel-powered vehicles, and the like. In particular, it is preferably used as a power supply for driving hybrid electric vehicle (HEV), plug-in hybrid electric vehicle (PHEV) or battery electric vehicle (BEV). Further, the battery may be used as a power source for a moving object (for example, a railway, a ship, or an aircraft) other than the vehicle, or may be used as a power source for an electric product such as an information processing apparatus.

### 2. Second Embodiment

As shown in the leftmost part of FIG. 2, the battery 10 according to the second embodiment includes the anode current collector 1, the metal layer 2, the electrolyte layer 3, and the cathode active material layer 4 in this order in the thickness direction. In addition, the metal layer 2 contains Mg−Ga alloy. Details of each member other than the metal layer 2 are the same as those described in the first embodiment.

The metal layer comprises Mg−Ga alloys. Mg−Ga alloy is an alloy including Mg and Ga, and may be a binary alloy including Mg and Ga, and may be an alloy including other elements in addition to Mg and Ga. In the latter-case, it is preferred that Mg and Ga are the main components in Mg−Ga alloy. In Mg−Ga alloy, the ratio of the sum of Mg and Ga to all the elements is, for example, 50 at % or more, may be 70 at % or more, and may be 90 at % or more.

The metal layers may have a metal phase (Mg−Ga alloy phase) of a Mg−Ga alloy, or may contain grains of a Mg−Ga alloy. The particles of Mg−Ga alloy are preferably nanoparticles having a mean particle diameter D₅₀ of 1 μm or less. The ratio of Ga to the sum of Ga and Mg (Ga/(Ga+Mg)) in the metal layers is not particularly limited. The preferred scope of Ga/(Ga+Mg) is the same as that described in the first embodiment. The metal layer preferably does not contain a conductive material. The metal layer preferably does not contain a binder. Also, in the second embodiment, the metal layers typically do not contain Li.

The metal layer is usually a dense layer. The porosity of the metal layer (the ratio of the area of the voids in the cross section of the metal layer) is, for example, 5% or less, may be 3% or less, and may be 1% or less. The metal layer may be a vapor-deposited film. The metal layer is preferably in close contact with the anode current collector. That is, the metal layer is preferably disposed so as to cover the surface of the anode current collector. A member including an anode current collector and a metal layer disposed on the anode current collector may be referred to as a coated current collector. In the second embodiment, the thickness of the metal layer is not particularly limited, but may be, for example, 30 nm or more and 5 μm or less, 100 nm or more and 3 μm or less, or 500 nm or more and 2 μm or less.

The battery according to the second embodiment includes an anode current collector, a metal layer, an electrolyte layer, and a cathode active material layer in this order in the thickness direction. In addition, batteries typically have an exterior body that houses these components. For configurations other than the metal layer, the contents are the same as those described in the “1. First embodiment.”

### B. Method for Manufacturing Battery

In the method for manufacturing a battery according to the present disclosure, a metal layer including a Mg−Ga alloy phase is formed by a vapor deposition method (metal layer forming step). Thereafter, a battery having an anode current collector, a metal layer, an electrolyte layer, and a cathode active material layer in this order in the thickness direction is assembled (assembling step). As a result, for example, the battery 10 shown in FIG. 1A is obtained. Thereafter, the battery is charged to form a Li−Mg alloy phase and a Li−Ga alloy phase from Mg−Ga alloy phase contained in the metal layer (charging step). As a result, for example, the battery 10 shown in FIG. 1B is obtained.

According to the present disclosure, by forming a specific metal layer, a battery having good discharge capacity characteristics can be obtained.

### 1. Metal Layer Forming Step

The metal layer forming step is a step of forming a metal layer including a Mg−Ga alloy phase by a vapor deposition method. The metal layer obtained by the vapor deposition method is a vapor deposition layer.

Examples of the vapor deposition method include physical vapor deposition (PVD) such as ion plating, sputtering, and vacuum vapor deposition. Preferably, Mg metal and Ga metal are each prepared and binary deposited.

In the present disclosure, a metal layer is preferably formed on the anode current collector by vapor deposition. This is because the anode current collector has high smoothness and a metal layer having a uniform thickness can be obtained. In this case, a metal layer may be directly formed on the anode current collector. On the other hand, a metal layer may be formed on the anode current collector via another layer (for example, another vapor deposition layer). Meanwhile, in the present disclosure, a metal layer may be formed on the solid electrolyte layer by a vapor deposition method. In this case, a metal layer may be directly formed on the solid electrolyte layer. On the other hand, a metal layer may be formed on the solid electrolyte layer via another layer (for example, another vapor deposition layer).

### 2. Assembling Step

The assembling step in the present disclosure is a step of assembling the battery having the anode current collector, the metal layer, the electrolyte layer, and the cathode active material layer in this order in the thickness direction. The method of assembling the battery is not particularly limited, and a known method can be employed.

### 3. Charging Process

The charging step is a step of charging the battery after the assembling step to form a Li−Mg alloy phase and a Li−Ga alloy phase from Mg−Ga alloy phase included in the metal layer. The charging condition of the battery is appropriately selected according to the configuration of the battery.

### 4. Battery

As for the batteries obtained through the above-described steps, the contents are the same as those described in “A. Battery”.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### Preparation of Positive Electrode

A nickel cobalt aluminum oxide (NCA) was prepared as a positive electrode active material, a Li₂—P₂S₅ sulfide solid electrolyte containing LiI and LiBr was prepared as a solid electrolyte (SE), a PVDF binder was prepared as a binder, and a vapor-grown carbon fiber (VGCF) was prepared as a conductive material. Next, NCA: SE:binder:conductive material=84.7:13.4:0.6:1.27 was added to butyl butyrate to obtain a positive electrode slurry. The obtained positive electrode slurry was coated on a positive electrode current collector (Al foil) with a coating gap of 225 μm, followed by temporary drying at 60° C. and drying at 165° C. for 1 hour. Thus, a positive electrode having a positive electrode current collector and a cathode active material layer was obtained. The basis weight of the cathode active material layer is 18.7 mg/cm², and the designed capacitance of the cathode active material layers is 3.0 mAh/cm².

### Preparation of Solid Electrolyte Layer

As a solid electrolyte (SE), a Li₂—P₂S₅ sulfide solid electrolyte containing LiI and LiBr was prepared, and a PVDF based binder was prepared as a binder. Then, SE was added to butyl butyrate at a ratio of 92.6:7.4 to obtain a slurry for the electrolyte layer. The obtained slurry was coated on a release film with a coating gap of 325 μm, followed by temporary drying at room temperature for 3 hours and drying at 165° C. for 1 hour. Thus, a laminate having a release film and a solid electrolyte layer was obtained. The resulting laminate was punched out with Φ14.5 mm, two punched out solid-state electrolyte layers were stacked and then pressed at a pressure of 7 ton. After the pressing, the release films located on both surfaces were peeled off to obtain a free-standing solid electrolyte layer.

### Preparation of the Negative Electrode

A stainless-steel foil (SUS foil) was prepared as the anode current collector. A Mg−Ga alloy-containing metal layer (thickness 1.0 μm) was formed on SUS foil by two-way deposition in an ion plating manner. A metal layer was formed. The target composition in the metal layers was on a Mg:Ga=75:25 (at % basis) and the actual composition was on a Mg:Ga=79:21 (at % basis). Thus, a negative electrode having an anode current collector and a metal layer was obtained.

### Preparation of Evaluation Cells

The resulting positive electrode was punched out with Φ11.28 mm, and the obtained negative electrode was punched out with Φ14.5 mm. Between them, free-standing solid-state electrolyte layers were placed, positive electrode tabs made of Al and negative electrode tabs made of Ni were attached, and vacuum-sealed in laminated films. The sealed cells were pressurized with 392 MPa by cold isotropic pressing (CIP). Thereafter, the cell was restrained by 1 MPa using a constant pressure fixture in which a spring was inserted so that the restraining pressure became constant regardless of the volume change of the cell. As a result, an evaluation cell was obtained.

### Example 2

An evaluation cell was obtained in the same manner as in Example 1, except that the target composition in the metal layer was changed to Mg:Ga=67:33 (at % standard). The actual composition in the metal layers was on a Mg:Ga=73:27 (at % basis).

### Example 3

An evaluation cell was obtained in the same manner as in Example 1, except that the target composition in the metal layer was changed to Mg:Ga=50:50 (at % standard). The actual composition in the metal layers was on a Mg:Ga=47:53 (at % basis).

### Example 4

An evaluation cell was obtained in the same manner as in Example 1, except that the target composition in the metal layer was changed to Mg:Ga=33:67 (at % standard). The actual composition in the metal layers was on a Mg:Ga=30:70 (at % basis).

### Example 5

An evaluation cell was obtained in the same manner as in Example 1, except that the target composition in the metal layer was changed to Mg:Ga=20:80 (at % standard). The actual composition in the metal layers was on a Mg:Ga=24:76 (at % basis).

### Comparative Example 1

An evaluating cell was obtained in the same manner as in Example 1, except that a metal layer containing a Mg metal was formed as the metal layer.

### Comparative Example 2

An evaluating cell was obtained in the same manner as in Example 1, except that a metal layer containing a Ga metal was formed as the metal layer.

### Evaluation

### Charge-Discharge Test

For the evaluation cells obtained in Examples 1 to 5 and Comparative Examples 1 and 2, first, the evaluation cells were charged and discharged at 60° C. by a constant current (current density: 0.15 mA/cm², 0.05 C equivalent)-constant voltage (cut-off current density: 0.03 mA/cm², 0.01 C equivalent) test at a cutoff voltage of 4.2V-3.0V.

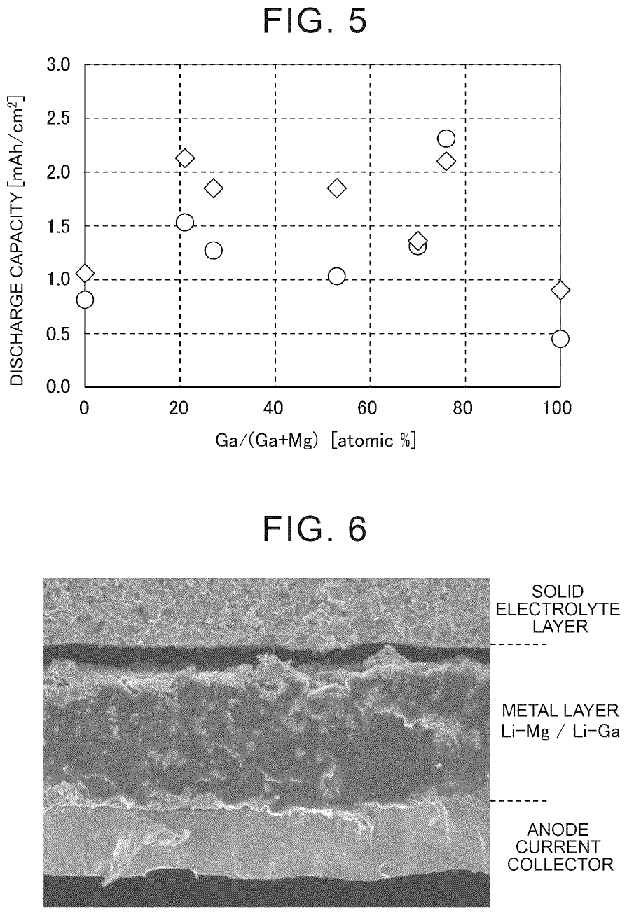

Next, as a cycling test, a constant current (current density: 0.60 mA/cm², 0.05 C equivalent)-constant voltage (only during charging, cut-off current density: 0.03 mA/cm², 0.01 C equivalent) test was performed at 25° C. with a cutoff voltage of 4.2V-3.0V. The results are shown in FIG. 4. Table 1 and FIG. 5 show the initial discharge capacity and the discharge capacity after 20 cycles in the cycle test.

TABLE 1

| | Metal layer | Initial discharge | Discharge capacity |
|---|---|---|---|
| | composition | capacity | after 20 cycles |
| | [atomic %] | [mAh/cm²] | [mAh/cm²] |
| Comparative | Mg:Ga = 100:0 | 1.06 | 0.81 |
| Example 1 | | | |
| Comparative | Mg:Ga = 0:100 | 0.91 | 0.45 |
| Example 2 | | | |
| Example 1 | Mg:Ga = 79:21 | 2.12 | 1.53 |
| Example 2 | Mg:Ga = 73:27 | 1.86 | 1.27 |
| Example 3 | Mg:Ga = 47:53 | 1.86 | 1.03 |
| Example 4 | Mg:Ga = 30:70 | 1.36 | 1.31 |
| Example 5 | Mg:Ga = 24:76 | 2.10 | 2.31 |

As shown in Table 1, FIG. 4, and FIG. 5, higher discharge capacities were obtained in Examples 1 to 5 than in Comparative Examples 1 and 2. More specifically, as shown in FIG. 5, in Examples 1 to 5, a discharge capacity higher than the discharge capacity estimated from the straight line connecting Comparative Examples 1 and 2 was obtained. As shown in FIG. 4, among Examples 1 to 5, in Examples 3 and 4, a singular phenomenon was confirmed in which the discharge capacity once decreased after the first discharge and the discharge capacity recovered by the subsequent charge and discharge. In this respect, it was confirmed that Ga/(Ga+Mg) is preferably in 50 at % or more and 85 at % or less.

On the other hand, as shown in FIG. 4, in Example 5, a remarkable result was obtained in which, after the first discharge, the discharge capacity did not decrease, and the discharge capacity was improved by the subsequent charge and discharge. In particular, the charge-discharge curves were quite different from those of Example 5 and Comparative Examples 1 and 2. Further, as shown in FIG. 5, compared to Examples 4 and 5 and Example 2, in Example 5, it was confirmed that the initial discharge capacity and the discharge capacity after 20 cycles were remarkably high. Therefore, it was confirmed that Ga/(Ga+Mg) is preferably in the vicinity of 76 at % (in 72 at % or more and 85 at % or less).

### SEM Observations

The evaluated cell obtained in Example 5 was subjected to cross-sectional observation by scanning electron microscopy (SEM). Specifically, the first charge was performed at 60° C. under the same conditions as described above, and the cross section thereof was observed by SEM in the secondary electronic images 5 kV the applied voltage. FIG. 6 shows these results. As shown in FIG. 6, the metal layer disposed between the solid electrolyte layer and the anode current collector increased from 1.0 μm to about 15 μm. This is because Mg and Ga contained in the metal layers are alloyed with Li, respectively. Further, although not shown in the drawings, an analysis of the elemental mapping by energy-dispersive X-ray spectroscopy (EDX) revealed that Mg is relatively uniformly dispersed in the metal layers. In contrast, it was confirmed that Ga is locally dispersed. That is, it was confirmed that a sea-island structure is formed in which Li−Mg alloy phase is sea and Li−Ga alloy phase is island.

The reaction potential of Mg's Li intercalation desorption is lower than 0.1V (vsLi/Li⁺), and the reaction potential of Li intercalation desorption of Ga is from about 0.1V to 0.8V (vsLi/Li⁺). In view of this relation, it is presumed that, during discharge, Li−Mg alloy phase is desorbed from Li alloy phase first, and at that time, Li−Ga alloy phase functions as a Li ion-conducting pass, so that the discharge capacitance becomes high. In particular, it is presumed that in the fifth embodiment, the locally dispersed Li−Ga alloy phase was effective for Li ionic conductivity. Further, considering the binary phase diagram of Mg−Ga alloy, Mg−Ga alloy in Example 5 (prior to the first charge), Ga₅Mg₂ single phase is generated, Li insert for Mg and Ga mixed at the molecular level, Li−Ga alloy phase after the first charge It is estimated that influenced the dispersed condition of the alloy phase. In addition, considering the difference in the reactive potentials of Li intercalation and deintercalation in Mg and Ga, it is presumed that redox of Li−Ga occurred in the low potential region (region below 3.5V) in the 60° C. charge-discharge curve, and redox of Li−Mg occurred in the other region.

What is claimed is:

1. A battery using a precipitation-dissolution reaction of metallic lithium as an anode reaction, the battery comprising an anode current collector, a metal layer, an electrolyte layer, and a cathode active material layer in this order in a thickness direction, wherein the metal layer contains a Li−Mg alloy phase and a Li−Ga alloy phase.

2. The battery according to claim 1, wherein a ratio of Ga to a total of Ga and Mg in the metal layer is equal to or higher than 5 at % and equal to or lower than 80 at %.

3. The battery according to claim 1, wherein a ratio of Ga to a total of Ga and Mg in the metal layer is equal to or higher than 72 at % and equal to or lower than 85 at %.

4. A battery using a precipitation-dissolution reaction of metallic lithium as an anode reaction, the battery comprising an anode current collector, a metal layer, an electrolyte layer, and a cathode active material layer in this order in a thickness direction, wherein the metal layer contains a Mg—Ga alloy.

5. A method for manufacturing a battery using a precipitation-dissolution reaction of metallic lithium as an anode reaction, the method comprising:
a metal layer forming step for forming a metal layer containing a Mg—Ga alloy phase by vapor deposition; and
an assembling step for assembling the battery including an anode current collector, the metal layer, an electrolyte layer, and a cathode active material layer in this order in a thickness direction.
